(19) United States
(12) Patent Application Publication
(10) Pub. No.: US 2024/0004775 A1
(43) Pub. Date: Jan. 4, 2024

(54) Methods and Devices for Anomaly Detection

(71) Applicant: TELEFONAKTIEBOLAGET LM ERICSSON (PUBL), Stockholm (SE)

(72) Inventor: Feng Liu, Beijing (CN)

(21) Appl. No.: 18/254,285

(22) PCT Filed: Dec. 1, 2021
(86) PCT No.: PCT/CN2021/134762

§ 371 Date: May 24, 2023

(30) Foreign Application Priority Data
Dec. 17, 2020 (WO) PCT/CN2020/137181

(51) Int. Cl. G06F 11/34

(52) U.S. Cl. CPC G06F 11/3452; G06F 11/3495

(57) ABSTRACT

A computer implemented anomaly detection method for detecting anomalies in a system, comprising: obtaining (301) a mean vector and a sketch matrix, wherein the mean vector is a mean of performance metric vectors indicating status of the system, and the sketch matrix is a sketch of an original matrix, the original matrix generated from subtracting the mean vector from each of the performance metric vectors, obtaining (302) a result of anomaly detection for at least one observational performance metric vector indicating status of the system, based on the mean vector and the sketch matrix. The corresponding apparatus, system, device, computer-readable storage and carrier, etc. thereof are also provided.

### TECHNICAL FIELD

The present disclosure generally relates to the technical field of anomaly detection, and more specifically to methods, apparatus, system, device, computer-readable storage and carrier, etc. for anomaly detection.

### BACKGROUND

This section is intended to provide a background for the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

An anomaly (which may also be known as: outlier, novelty, noise, deviation, rare value or exception etc.) can be defined as anything that differs from expectations. In the field such as computer science, networking, industrial applications, etc., anomaly detection refers to identifying data, events or conditions which do not conform to an expected pattern or to other items in a group. Encountering an anomaly may in some cases indicate a processing abnormality and thus may present a starting point for investigation. So it is mostly used in predictive maintenance. Traditionally, anomalies are detected by a human being by studying information that can come from an application, process, operating system, hardware component, and/or a network. Never an easy job, given the current complexity of today's computer systems, networking, industrial applications, etc., it is a job that is rapidly becoming close to impossible for a human.

### SUMMARY

It is one or more object(s) of the present disclosure to address one or more of the problems arisen in detection of anomalies.

According to a first aspect of the disclosure, there is provided a method for anomaly detection in a system. The method comprises obtaining a mean vector and a sketch matrix. The mean vector is a mean of performance metric vectors indicating status of the system, and the sketch matrix is a sketch of an original matrix that is generated from subtracting the mean vector from each of the performance metric vectors. The method also comprises obtaining a result of anomaly detection for at least one observational performance metric vector indicating status of the system, based on the mean vector and the sketch matrix.

In an example, in response to determining a cold start process is required, the obtaining the mean vector and the sketch matrix may comprise: obtaining performance metric vectors indicating status of the system within the time period, obtaining the mean vector, which results from calculation of a mean of the performance metric vectors indicating status of the system within the time period, obtaining subtracted performance metric vectors within the time period, which result from subtraction of the mean vector from each of the performance metric vectors indicating status of the system within the time period, and obtaining the original matrix, which is generated from the subtracted performance metric vectors within the time period. The cold start process is a process where the system is run for generating the performance metric vectors indicating status of the system for a time period and statistics comprising the mean vector and the sketch matrix are calculated according to the performance metric vectors generated in the process.

In an example, the cold start process may be determined to be required when: the status of the system has changed abruptly, the system starts up for the first time, the system is upgraded with regard to any of its component, at least part of components of the system is replaced, or it is at time predefined for a regular cold start process.

In an example, the system may comprise a plurality of subsystems that shares a job evenly and the performance metric vectors indicating status of the system comprises performance metric vectors indicating status of each of the subsystem.

In an example, the obtaining the sketch matrix of the original matrix may comprise: reading the original matrix once.

In an example, in case that the original matrix is generated with each row of the original matrix being one of the subtracted performance metric vectors, the sketch matrix of the original matrix may comprise any of the following: a Frequent Direction sketch matrix of the original matrix, a sketch matrix obtained by randomly combining rows of the original matrix, or by randomly combining rows of the original matrix, or a sketch matrix obtained by generating a sparser version of the original matrix. Whether the sketch matrix is generated on rows of the original matrix, or on columns of the original matrix, depends on how the original matrix is generated.

In an example, the obtaining the result of anomaly detection may comprise: obtaining principle subspace of the sketch matrix using Principal Component Analysis, obtaining a projection value of each of the at least one observational performance metric vector on at least part of the principle subspace, wherein the at least part of the principle subspace is partial rank or full rank principle subspace, and obtaining the result of anomaly detection from the projection value.

In an example, the projection value may comprise any of the following: a leverage score on at least part of the principle subspace, or a projection distance on at least part of the principle subspace.

In an example, the anomaly detection method may further comprise: in response to that an anomaly is detected from the result, reporting the anomaly.

In an example, the anomaly detection method may further comprise: in response to no anomaly is detected in one of the at least one observational performance metric vector from the result, updating the mean vector and the sketch matrix with the one of the at least one observational performance metric vector.

In an example, the anomaly detection method may be performed on an edge side of a network.

In an example, the system comprises any of the following: a hardware system, software system, or environmental system.

In an example, the system may comprise at least an entity of a 5G network.

In an example, the original matrix may be generated with each row of the original matrix comprising a respective one vector of the subtracted performance metric vectors.

In an example, the at least one observational performance metric vector may be generated in real time, so that anomalies may be detected in early time.

According to a second aspect of the disclosure, there is provided an apparatus for anomaly detection in a system. The apparatus comprises: a statistics obtaining component and an anomaly detection component. The statistics obtaining component is configured to obtain a mean vector and a sketch matrix. The mean vector is a mean of the performance metric vectors indicating status of the system. The sketch matrix is a sketch of an original matrix generated from subtracted performance metric vectors. The subtracted performance metric vectors results from subtracting the mean vector from each of the performance metric vectors. The anomaly detection component is configured to obtain a result of anomaly detection for at least one observational performance metric vector indicating status of the system, based on the mean vector and the sketch matrix.

According to a third aspect of the disclosure, there is provided a communication device in a communication network. The communication device comprises a storage adapted to store instructions therein and a processor adapted to execute the instructions to cause the communication device to perform the steps of any of the methods herein.

According to a fourth aspect of the disclosure, there is provided an anomaly detection system. The anomaly detection system comprises: at least one agent entity, configured to collect performance metric data used for generating performance metric vectors indicating status of a system, and an anomaly detection apparatus of the second embodiment, or a communication device of the third embodiment.

According to a fifth aspect of the disclosure, there is provided a computer-readable storage. The computer-readable storage stores computer-executable instructions thereon, when executed by a computing device, causing the computing device to implement the method of any of any of the methods herein.

According to a sixth aspect of the disclosure, there is provided a computer program product. The computer program product comprises instructions which, when executed on at least one processor, cause the at least one processor to carry out the method according to any one of the methods herein.

According to a seventh aspect of the disclosure, there is provided a carrier containing the computer program of the eighth embodiment, wherein the carrier is one of an electronic signal, optical signal, radio signal, or computer readable storage.

According to an eighth aspect of the disclosure, there is provided an apparatus adapted to perform the method according to any one of the methods herein.

According to embodiments of the present disclosure, at least by generating a matrix from vectors resulted from subtracting the mean vector from observational performance metric vectors, accuracy in anomaly detection may be enhanced.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and details through use of the accompanying drawings.

FIG. 1 illustrates an example environment where embodiments of the present disclosure may apply.

FIG. 2 illustrates a schematic view of the process of anomaly detection according to embodiments of the present disclosure.

FIG. 3a illustrates a flowchart of anomaly detection according to embodiments of the present disclosure.

FIG. 3b illustrates a flowchart of cold start for anomaly detection according to embodiments of the present disclosure.

FIG. 3c illustrates an example anomaly detection algorithm for detecting anomaly for at least one observational performance metric vector according to embodiments of the present disclosure.

FIG. 3d illustrates the performance of embodiments of the present disclosure as compared to that of a benchmark.

FIG. 4a illustrates a streaming process for anomaly detection in a schematic view of an anomaly detection system according to embodiments of the present disclosure.

FIG. 4b illustrates the streaming process for anomaly detection in another schematic view according to embodiments of the present disclosure.

FIG. 5 illustrates the principle of subspace learning in anomaly detection according to embodiments of the present disclosure.

FIG. 6 illustrates a schematic block diagram of a communication device according to embodiments of the present disclosure.

FIG. 7 schematically illustrates an embodiment of an arrangement which may be used for anomaly detection according to embodiments of the present disclosure.

### DETAILED DESCRIPTION

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first request and a second request indicate different requests regardless of the order or importance.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a storage device.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein, for example, concepts of leverage score, principle subspace, etc. are generally understood in the context of machine learning. Though many embodiments herein are described in the context of Next Generation network (such as 5G communication networks), other networks may also be applicable.

Even though many embodiments are described in the context of unsupervised anomaly detection, it is noted that embodiments of the present disclosure are not limited to unsupervised anomaly detection, but also applicable to supervised or semi-supervised anomaly detection as appropriate.

Anomalies such as deterioration and lifetime of installed batteries etc. which must be discovered in early stages, are prevalent in many hardware systems, for example, base stations in e.g. 5G network, network devices of any network, lamps inside or outside, water turbines in water power plants, nuclear reactors in atomic power plants, wind turbines or wind driven generator in wind power plants, engines in aircraft and heavy machinery, railway vehicles and rails, escalators, elevators, medical apparatus such as MRI, manufacturing equipment and inspection devices and even at levels of their tools and parts for semiconductors and flat panel displays, various kinds of things in Internet of Things (IoT), and software systems as well, such as software systems of servers in a cloud platform. Even it is becoming important to detect anomalies (various symptoms) of the human body as encountered in measurement and diagnosis of brain waves for the sake of health management, or environment as encountered in measurement for forecast. Detection of anomalies of these systems is of great importance in predictive maintenance.

Generally, an architecture that monitors observational data, compares the data with a set threshold value based on a set of rules, and detects anomalies is often used. In this case, the threshold value is set while taking notice of a physical amount of a subject to be measured that is each piece or set of observational data. Therefore, such a detection can be referred to as rule-based anomaly detection.

Defining rules and thresholds need a lot of professional knowledge, and it is difficult to detect an anomaly which was not considered in the rule, consequently, it is almost impossible to migrate one such monitoring architecture for one specific filed to a different filed. Besides, even for one specific filed, rule and threshold may vary under different circumstances. For example, the set threshold value may be no longer appropriate because of impacts of the environment in which an equipment is running, state variations due to years of operation, operating conditions, and replacement or updates or upgrades of parts.

Nowadays, people try to use machine learning algorithms for detecting anomalies. The machine learning based anomaly detection is classified as supervised, semi-supervised or unsupervised, based on the availability of reference data that acts as a baseline to define what is normal and what an anomaly is. Supervised anomaly detection typically involves training a classifier, based on a first type of data that is labeled “normal” and a second type of data that is labeled “abnormal”. Semi-supervised anomaly detection typically involves construction of a model representing normal behavior from one type of labeled data: either from data that is labeled normal or from data that is labeled abnormal but both types of labeled data are not provided at the same time. Unsupervised anomaly detection detects anomalies in data where data is not manually labeled by a human.

For supervised learning methods: people need to collect data and label them, which is time consuming and probably beyond human endeavor. For semi-supervised learning methods, data should be classified, which is also time consuming. For supervised learning method, accuracy differs among different algorithms, and storage use and computation efficiency is the main problem in application.

Accordingly, it is at least an object of the present invention to enable an anomaly detection that solves at least one of the above mentioned problems.

Environments where embodiments of the present disclosure may apply involve networks. Entities involved in the embodiments of the present disclosure are entities of the network. A network is a geographically distributed collection of nodes interconnected by communication links and segments for transporting data between nodes, such as personal computers, portable devices, servers, or other devices, such as sensors, etc. Many types of networks are available, with the types ranging from local area networks (LANs) to wide area networks (WANs), from wireless networks to wired networks. LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, natural resource consumption (e.g., water/gas/etc. for advanced metering infrastructure or “AMI” applications) temperature, pressure, vibration, sound, radiation, motion, pollutants, etc., all of which could be taken as observational data, and used in embodiments of the present disclosure. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered in field area networks (FANs), neighborhood area networks (NANs), personal area networks (PANs), etc.

The network may also include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, storage, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture.

Mobile communication system, such as second-generation (2G) communication systems, third-generation (3G) communication systems, fourth-generation (4G) communication systems, and fifth-generation (5G) communication systems is another important kind of network. An indispensable part of a mobile communication system includes a radio access network part (Radio Access Network, RAN) and a core network part (Core Network, CN). Among them, the radio access network is responsible for processing all wireless-related functions, while the core network processing system is responsible for the switching and routing of all voice calls and data connections with external networks. The above two units and User Equipment (UE) together constitute the entire system. The network unit of the wireless access network includes base stations, which form the edge of the mobile communication system.

Edge computing, as the name implies, involves pushing data and computing power away from a centralized point to the logical extremes or edges of a network. Edge computing is useful for reducing the data traffic in a network, which is important as the computer industry addresses the fact that bandwidth within networks is not unlimited or free. Edge computing also removes a potential bottleneck or point of failure at the core of the network and improves security as data coming into a network typically passes through firewalls and other security devices sooner or at the edges of the network.

The growing trend is toward relatively large numbers of low-cost commodity network appliances or nodes. Each network node typically has limited computing power, e.g., limited processors, processor speed, storage, storage, network bandwidth, and the like, which is compensated by the large number of network nodes. Some edge computing networks are even designed to include desktop computers and off-load work to idle or underutilized systems. One problem with edge computing systems is that as the number of the network nodes increases, the complexity of the installation also increases. Many nodes are often configured with excess capacity to support estimated peak loads, but these computing resources are underutilized for large percentages of service life of the node. As a result, there is a growing demand for effective management of the network resources and utilization of networked resources and nodes to obtain more of the performance, functional, and cost benefits promised by edge computing.

An edge computing node (Edge Computing Node, ECN) in mobile communication systems is a functional node deployed in a base station or a convergence point of the base station or core network. Its specific role is to process traffic data, reduce the amount of traffic data transferring from the deployment location to the core network and external networks, reduce the delay for UE services, and improve user experience.

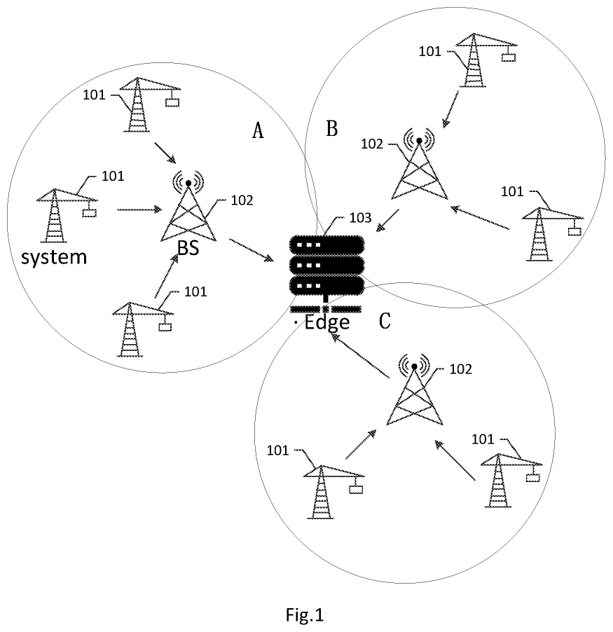

Though many different kinds of networks are introduced above, we only describe an example environment where embodiments of the present disclosure can be applied in detail in FIG. 1. It is noted that embodiments of the present disclosure are not limited to the example environment shown in FIG. 1, but are applicable to numerous kinds of networks as appropriate, including those mentioned above.

As shown in FIG. 1, systems 101 are the target to be monitored. The system 101 comprises any of hardware systems, for example, base stations in e.g. 5G network, network devices of any network, lamps inside or outside, water turbines in water power plants, nuclear reactors in atomic power plants, wind turbines or wind driven generator in wind power plants, engines in aircraft and heavy machinery, railway vehicles and rails, escalators, elevators, medical apparatus such as MRI, manufacturing equipment and inspection devices and even at levels of their tools and parts for semiconductors and flat panel displays, various kinds of things in Internet of Things (IoT), and software systems as well, such as software systems of servers in a cloud platform, even human body as encountered in measurement and diagnosis of brain waves for the sake of health management, or environment as encountered in measurement for forecast, or food storage, or plants growing, or animals feeding, etc. Detection of anomalies of these systems is of great importance in predictive maintenance, while in some cases, detection of anomalies of these systems on historical data may help analyze the reasons of malfunctions.

In a scenario, several systems 101 share a job evenly, i.e., the systems share a similar job situation, with one system busy, all the systems busy, e.g. software systems of several servers in one cloud platform shares a traffic load, base stations of a 5G network in an area share the service providing job in this area, temperature controllers in a growing plant area share a same environment controlling job, etc. These several systems 101 sharing a job can be regarded as one whole system, with each single one regarded as a subsystem of the whole system. Anomaly detection can then be done on the whole system, which is more robust than on a single basis. Take a cluster of servers for example, if a cluster of servers provides SaaS service to external users, it is reasonable to assume that the servers in this cluster are sharing a job evenly (i.e., doing similar jobs) at one particular time, since the load balancer/cluster scheduler is trying to dispatch tasks and allocate resources evenly. If a sudden job of huge computations comes to this platform, all servers will increase their resources utilization suddenly. If judging on the basis of a single server, one will consider this situation as abnormal. But if judging on the basis of multiple servers at the same time, since their resource utilizations are all increased, one will not consider this situation as abnormal.

Observational data of one or more systems 101 is transmitted to a serving based station 102 in e.g. a 5G network, which may act as an edge computing node and take the responsibility of anomaly detection (this scenario is not shown in FIG. 1). The base station 102 may further transmit the observational data to an edge computing node 103 for anomaly detection in case that the base station 102 is not the edge computing node itself (this scenario is shown in FIG. 1). Though FIG. 1 shows that the networks A, B and C for transmitting the observational data is of the same type, it is noted that the networks A, B and C may be of different types. For example, network A is a new radio network, network B is a mesh network, and network C is a PLC network, etc., and meanwhile they are connected to a same edge computing node.

FIG. 1 shows an area covered by three base stations 102 managed by an edge computing node 103, each of the base station 102 covering several monitored systems 101, data from which will be transmitted to the edge computing node 103 via base stations 102 and be processed as a whole for anomaly detection in the edge computing node 103. However, embodiments of the present disclosure are not limited to such a scenario, and anomaly detection can also be done on data from a single system.

Processing at the edge computing node will reduce the amount of traffic data transferring from the deployment location to the core network or external networks, reduce the delay for UE services, and improve user experience. Edge computing also removes a potential bottleneck or point of failure at the core of the network and improves security in that data coming into a network typically passes through firewalls and other security devices before or at the edges of the network. The edge computing node, such as edge 102 in FIG. 1, or a base station such as a 5G base station, may be deployed in and owned by a plant, and thus anomaly detection performed on the edge computing node not only reduces transmission bandwidth, but also saves data leakage and thus ensures privacy.

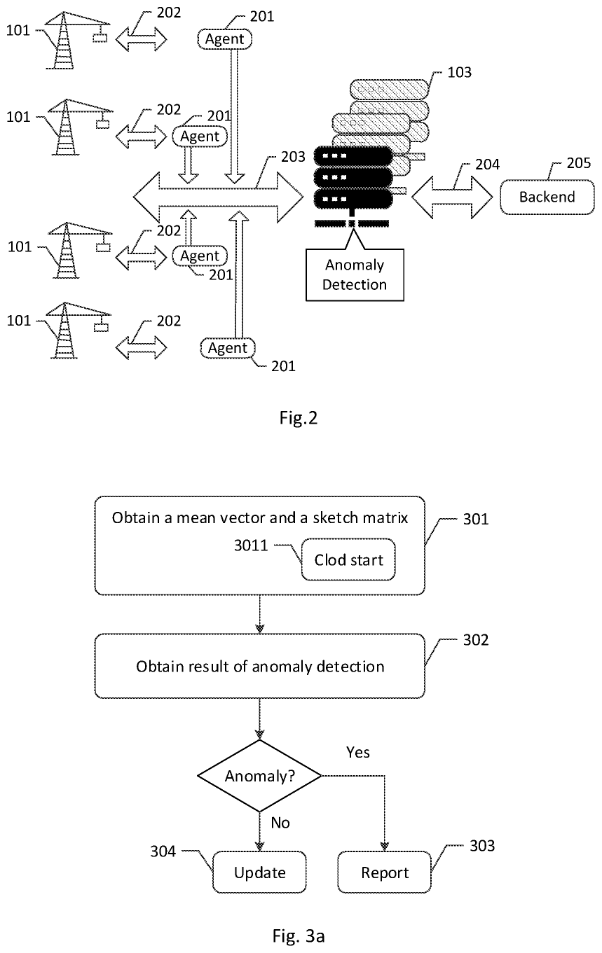

FIG. 2 illustrates a schematic view of the process of anomaly detection according to embodiments of the present disclosure. Each of the monitored system 101 is in connection with an agent 201 via a connection 202. The monitored system 101 could be any of the hardware, software, or environment as described above.

The agent 201 is configured to collect any necessary observational data, herein also referred to as performance metric data, as the data reflects performance metrics of status of the system, for example, CPU load, storage usage, trace log information, voltage, vibration, temperature, pressure, running time, or the like. The installation environment conditions or the like may also be collected, etc. In an example, the agent 201 may comprise a software component made up of a piece of code attached to or in communication with the system 101 to collect the performance metric data, the system in the example may be e.g. a software system. In another example, the agent 201 may comprise at least a sensor for collecting the performance metric data, the system in the example may be e.g. a hardware system. In an example, the agent 201 comprises a communication component that could enable data transmission to an edge computing node 103 via a connection 203, either directly or via one or more intermediate nodes. An example of such an agent is a network terminal, such as a UE in a radio network, an object in IoT, etc. In another example, data collected by the agent 201 may be transmitted via a communication component of the monitored system to an edge computing node 103, either directly or via one or more intermediate nodes, via a connection 203. An example of such an agent is a component connected to the communication component of the monitored system. The agent 201 may have a connection 202 with the monitored system 101 for data collecting or data transmission. The connection 202 comprises e.g. a bus connection, a wireless connection, or any other type of connection as appropriate. The agent 201 also has a connection 203 with the edge computing node 103 for data transmission. The connection 203 comprises e.g. a wireless connection, or any other type of connection as appropriate.

The performance metric data comprises multidimensional data (such as two dimensions of CPU load and storage usage) and this data will be processed to form vectors (such as each vector comprising two components of CPU load and storage usage) in any suitable node. The sampling timing of data collecting varies greatly, for example, from tens of milliseconds to tens of seconds, and may be determined by a user.

The edge computing node 103 has a relatively strong processing ability that can perform anomaly detection based on the performance metric data collected by the agent 201. The data transmitted from the agent 201 may be already processed as vectors, or is processed in the edge computing node 103 or any intermediate node to be vectors, which is not limited in the present disclosure.

In some embodiments, anomaly detection is performed in the edge computing node 103, which will be described in more detail below. While in some embodiments, anomaly detection can also be performed in a backend, which is a node farther from the monitored system than the edge computing node 103.

In some embodiments, anomaly detection is performed in the edge computing node 103, and a report may be sent to the backend 205, e.g. in case that an anomaly is detected.

A connection 204 provides connectivity between the edge computing node 103 and the backend 205. The connection 205 could be a connection of any type of the network as described above as appropriate, such as a 5G core network connection, an internet connection, etc. One backend may act as a center monitor and be connected to a plurality of such edge computing node 103 for anomaly detection for different kinds of systems.

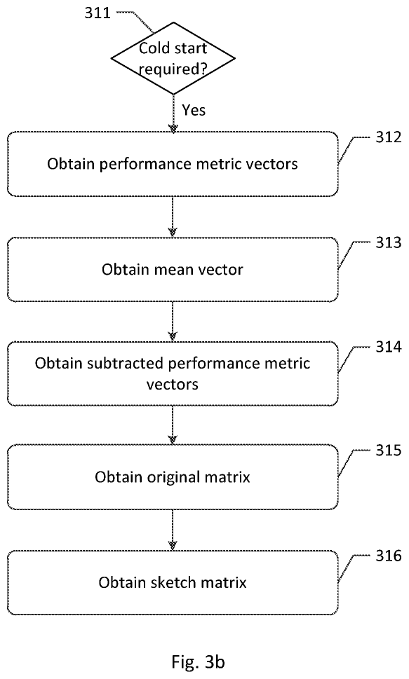

FIG. 3a illustrates a flowchart of anomaly detection for detecting anomalies in a system according to embodiments of the present disclosure.

The method starts at step 301, where a mean vector and a sketch matrix are obtained. Given the performance metric data of a system sᵢ (i being the index of the system) collected by the agent 201 at time point tⱼ (j being the index of the time point) is transformed as performance metric vectors Vₚ, denoted respectively as Vₛᵢₜⱼ={vᵢⱼ₁, vᵢⱼ₂, . . . , vᵢⱼₙ}, each of the components vᵢⱼ₁, vᵢⱼ₂, . . . vᵢⱼₙ represents a performance metric of status of the monitored system sᵢ at a time point tⱼ, such as CPU load, storage usage, temperature, etc.

In an example, there is only one system under monitoring, then the vectors comprises simply performance metric vectors of the system of different time points, e.g. within a time duration such as an hour, represented as Vₜ₁, Vₜ₂, . . . , Vₜₘ, wherein m is the number of time points sampled, and each of the Vₜ₁, Vₜ₂, . . . , Vₜₘ comprises {vⱼ₁, vⱼ₂, . . . , vⱼₙ}, j is an index of the time points, and j={1, 2, . . . m}.

In an example, there are multiple systems under monitoring sharing a job evenly, then the vectors comprises performance metric vectors of the multiple systems, preferably of different time points, e.g. within a time duration such as an hour, represented as Vₛ₁ₜ₁, Vₛ₁ₜ₂, . . . , Vₛ₁ₜₘ, . . . Vₛ₂ₜ₁, Vₛ₂ₜ₂, . . . , Vₛ₂ₜₘ, . . . Vₛₖₜ₁, Vₛₖₜ₂, . . . , Vₛₖₜₘ, wherein m is the number of time points sampled, k is the number of systems under monitoring sharing a job evenly, and each of the vectors Vₛ₁ₜ₁, Vₛ₁ₜ₂, . . . , Vₛ₁ₜₘ, . . . Vₛ₂ₜ₁, Vₛ₂ₜ₂, . . . , Vₛ₂ₜₘ, . . . Vₛₖₜ₁, Vₛₖₜ₂, . . . , Vₛₖₜₘ comprises all the components {vᵢⱼ₁, vᵢⱼ₂, . . . , v_{ijn}}i is an index of the systems, and i={1, 2, . . . k}, j is an index of the time points, and j={1, 2, . . . m}.

But there may be some scenarios that performance metric vectors of the multiple systems at only one time point is sufficient, where the number of systems under monitoring is huge, and the status of the systems probably do not vary much by time. In such scenarios, the performance metric vectors of the multiple systems are represented as Vₛ₁, Vₛ₂, . . . , Vₛₖ, wherein k is the number of systems, and each of the vectors Vₛ₁, Vₛ₂, . . . , Vₛₖ comprises {vᵢ₁, vᵢ₂, . . . , vᵢₙ}, i is an index of the systems, and i={1, 2, . . . k}.

The mean vector Vₘₑₐₙ is then calculated by averaging all the performance metric vectors:

$${V}_{mean} = {\sum }_{i = 1}^{k} {\sum }_{j = 1}^{m} {V}_{ij} .$$

Then subtracted vectors V_{sub} is calculated by subtracting the mean vector from each of the performance metric vectors: V_{sub}=Vₚ−Vₘₑₐₙ. Then all the subtracted vectors V_{sub} form an original matrix A, with each subtracted vector being e.g. a row of the original matrix A. Order of the vectors in forming respective rows is not limited, and can be based on order of generation of the vectors. Embodiments below will be based on such a matrix, while it is noted that the subtracted vectors V_{sub} may also form the original matrix with each subtracted vector being a column of the original matrix, and the present disclosure does not aim to limit on this.

Then a sketch matrix which is a sketch of the original matrix will be obtained from the original matrix. The sketch matrix is a storage efficient approximation of the original matrix. Sketch B of matrix A∈R^{n×m} has the property that for example B∈ [symbol] containing only [symbol] <<n rows, but still guarantees that A^{T}A≈B^{T}B. More accurately:

∀χ,∥χ∥=1,0≤∥Aχ∥²−∥Bχ∥²≤2∥A∥_{f}²/ [symbol] ,

or

B^{T}B [symbol] A^{T}A and ∥A^{T}A−B^{T}B∥≤2∥A∥_{f}²/ [symbol] .

Since the corresponding sketch can be viewed as preserving the row space of A, such a sketch may be referred to as row space approximations.

Sketch B of a matrix A∈R^{n×m} where B∈R^{n×d} containing only d<<m columns applies similarly, and can be viewed as preserving the column space of A, and thus referred to as column space approximations.

A good sketch matrix B is such that computations can be performed on B rather than on A without much loss in precision. Matrix sketching methods are, therefore, designed to be pass-efficient, i.e., the data is read at most a constant number of times. If only one pass is required, the computational model is also referred to as the streaming model. The streaming model is especially attractive since a sketch can be obtained while the data is collected. In the streaming model, the data may come in continuously and processed immediately.

According to embodiments of the present disclosure, in case that the original matrix is generated with each row of the original matrix being one of the subtracted performance metric vectors, the sketch matrix of the original matrix comprises any of the following:
(1) a Frequent Direction sketch matrix of the original matrix,
(2) a sketch matrix obtained by randomly combining rows of the original matrix, or by randomly combining columns of the original matrix, or
(3) a sketch matrix obtained by generating a sparser version of the original matrix, all of which may enable the streaming model.

There are a lot of ways of matrix sketching, which may enable the streaming model, and embodiments of the present disclosure do not aim to be limited to the above three sketch matrices.

As is known by a skilled person, the sketch matrix may be generated on rows of the original matrix, or on columns of the original matrix, depending on how the original matrix is generated, i.e., for the original matrices with each row being a subtracted vector, the sketch matrix could be generated on rows of the original matrix, and for the original matrices with each column being a subtracted vector, the sketch matrix could be generated on columns of the original matrix.

Given any matrix A∈R^{n×m}, a frequent Direction sketch matrix is generated by processing the rows of A one by one and produces a sketch matrix B∈ [symbol] , such that

B^{T}B [symbol] A^{T}A and ∥A^{T}A−B^{T}B∥≤2∥A∥_{f}²/ [symbol] .

The intuition behind Frequent-directions is that the Frequent-directions periodically ‘shrinks’ [symbol] orthogonal vectors by roughly the same amount. This means that during shrinking steps, the squared Frobenius norm of the sketch reduces [symbol] times faster than its squared projection on any single direction. Since the Frobenius norm of the final sketch is non negative, we are guaranteed that no direction in space is reduced by “too much”.

The obtaining of the mean vector and the sketch matrix at step 301 comprises receiving them from one or more other function entities, or generating them locally.

At step 302, a result of anomaly detection for at least one observational performance metric vector indicating status of the system is obtained based on the mean vector and the sketch matrix obtained at step 301. Herein observational performance metric vector is simply to differ from those performance metric vectors in step 301 by name, without affecting content types of the vector. The at least one observational performance metric vector may be real time from the agent 201, for early detecting anomaly in the system, or may be historical, for analyzing causes of a malfunction. The obtaining of the result at step 302 may also comprise receiving them from one or more other function entities, or generating them locally.

There are several ways of anomaly detection algorithms to obtain the result based on the mean vector and the sketch matrix, such as the subspace learning algorithm. The purpose of subspace learning algorithms is to transform or map the original high-dimensional data into another lower-dimensional feature subspace. According to the property of the mapping function, subspace learning algorithms may be classified into linear and nonlinear algorithms. Linear subspace learning algorithms, such as Principal Component Analysis (PCA), Linear Discriminant Analysis (LDA), Latent Semantic Indexing (LSI), k-means, and Locality Preserving Indexing (LPI), are more widely used. Whereas nonlinear algorithms, such as the Locally Linear Embedding (LLE) and Laplacian Eigen maps, are less used due to their high computational complexity.

Different subspace learning algorithms are used for different goals. For instance, Principal Component Analysis (PCA), Latent Semantic Indexing (LSI) and k-means was commonly used for unsupervised clustering problems and the Linear Discriminant Analysis (LDA) was used for classification problems. FIG. 3c describes a specific example in detail, where the PCA algorithm is used.

Then at step 303, in response to that an anomaly is detected, the anomaly is reported, e.g. via a user interface to a user, or to a backend node for further processing.

In case that no anomaly is detected in one of the at least one observational performance metric vector as indicated in the result, optionally, the mean vector and the sketch matrix with the one of the at least one observational performance metric vector are updated at step 304.

The mean vector meanₜ₋₁ at time t−1 is updated to be the mean vector meanₜ at time t as follows:

meanₜ=(Nₜ₋₁*meanₜ₋₁+observational performance metric vector)/(Nₜ₋₁+1),

wherein Nₜ, and Nₜ₋₁ are numbers of samples at time t and time t−1 respectively, and Nₜ=Nₜ₋₁+1.

In an example of frequent directions for matrix sketching, the algorithm keeps an [symbol] ×m sketch matrix B that is updated every time a new row from the input matrix (i.e. the original matrix) A is added. Rows from matrix A simply replace all-zero valued rows of the sketch B. The algorithm maintains the invariant that all-zero valued rows always exist. Otherwise, half the rows in the sketch are nullified by a two-stage process. First, the sketch is rotated (from the left) using its SVD such that its rows are orthogonal and in descending magnitude order. Then, the sketch rows norms are “shrunk” so that at least half of them are set to zero. In the algorithm, we denote by [U, Σ, V]=SVD(B) the Singular Value Decomposition of B. We use the convention that UΣV^{T}=B, U^{T}U=V^{T}V=VV^{T}= [symbol] , where [symbol] stands for the [symbol] × [symbol] identity matrix. Moreover, Σ is a non-negative diagonal matrix such Σ=diag([ [symbol] ₁, . . . , [symbol] ]), [symbol] ₁≥ . . . ≥ [symbol] ≥0. We also assume that [symbol] is an integer.

The sketch matrix is updated as shown in the following algorithm:

Regarding cache size [symbol] , A∈R^{n×m}, subtracted performance metric vector (i.e., the observational performance metric vector subtracting the mean vector) aᵢ as a row vector coming in a streaming manner (i.e., coming in continuously), B=all zeros matrix ∈ [symbol] , the median of all singular values

$${σ}_{\frac{ℓ}{2}}^{2} ,$$

the number of systems under monitoring k, and the number of time points sampled m:

For i in [1, n], do:

Insert aᵢ to a zero valued row of B
If B has no zero valued row, then:

[U,Σ,V]=svd(B)

$$δ = {σ}_{\frac{ℓ}{2}}^{2}$$

$$\hat{\sum } = \sqrt{max ( {\sum }^{2} - {I}_{ℓ} δ , 0 )}$$

B=\hat{Σ}V^{T}#At least half the rows of B are all zero
End if
End for
Return: B.

Alternatively or additionally, for aᵢ as a column vector, the algorithm is similar, except that “Insert aᵢ to a zero valued column of B” instead of “Insert aᵢ to a zero valued row of B”, and “B=U\hat{Σ}” instead of “B=\hat{Σ}V^{T}”.

This algorithm is very efficient and light weighted in that, only a [symbol] ×m matrix space is required in the storage, with [symbol] being a small number as compared to n. Therefore, the algorithm can be deployed at the edge side.

There are some cases where there are not sufficient samples or accurate samples for obtaining statistics such as the mean vector and the sketch matrix. The cases comprise any of the following: an abrupt change case when the status of the system has changed abruptly, a system start up case when the system starts up for the first time, a system upgrade case when the system is upgraded with regard to any of its component, a system replacement case when at least part of components of the system is replaced, or a regular case when it is time for regular cold start.

Then a cold start 3011 is needed in step 301. The cold start is a process where the system is run for generating the performance metric vectors indicating status of the system for a time period and statistics comprising the mean vector and the sketch matrix are calculated according to the performance metric vectors generated in the process.

Performance of the method as illustrated in FIG. 3a has been studied in a test as compared to a bench mark method where the only difference lies in that the original matrix is obtained directly from the observational performance metric vectors without subtracting the mean vector. In the test, the public dataset of Schwan's is obtained as the input data, performance of the two methods is shown in FIG. 3d, where x axis is the cache length, y axis represents the F-score (in which precision and recall are equally weighted). The higher the F-score is, the better the method is. The upper line in the figure shows that method of FIG. 3a applying the mean vector has better performance than the method without applying the mean vector as in the benchmark. By generating a matrix from vectors resulted from subtracting the mean vector from observational performance metric vectors, accuracy in anomaly detection may be enhanced.

FIG. 3b illustrates a flowchart of cold start for anomaly detection according to embodiments of the present disclosure. At step 312, performance metric vectors indicating status of the system within the time period are obtained. At step 313, the mean vector resulted from calculating a mean of the performance metric vectors indicating status of the system within the time period is obtained. At step 314, subtracted performance metric vectors within the time period, resulted from subtracting the mean vector from each of the performance metric vectors indicating status of the system within the time period, are obtained. At step 315, the original matrix generated from the subtracted performance metric vectors within the time period is obtained, and at step 316, the sketch matrix of the original matrix is obtained. It is noted that the “obtain” here comprise receiving from one or more other function entities, or generating locally.

Additionally or alternatively, at step 311 before step 312, a determination is made regarding whether a cold start process is required. The cold start process is determined to be required when: the status of the system has changed abruptly, the system starts up for the first time, the system is upgraded with regard to any of its component, at least part of components of the system is replaced, or it is at time predefined for a regular cold start process.

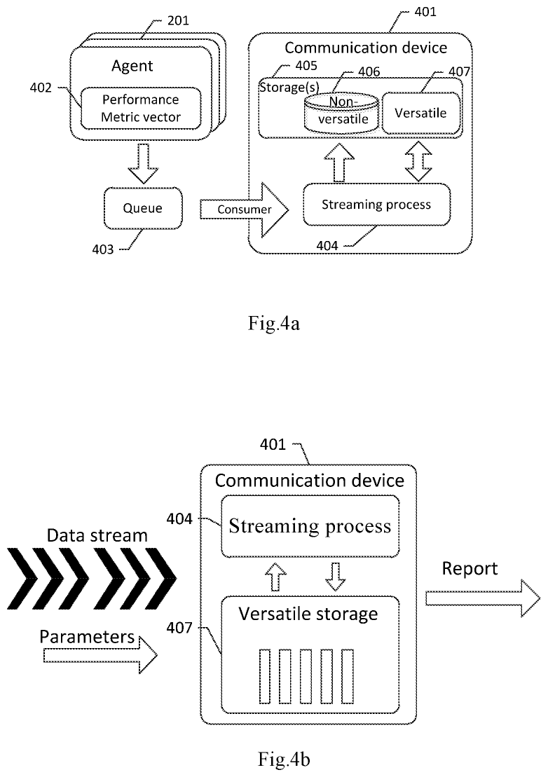

FIG. 3c illustrates an example anomaly detection algorithm for detecting anomaly for at least one observational performance metric vector based on the mean vector and the sketch matrix. At step 331, principle subspace of the sketch matrix using Principal Component Analysis is obtained. FIG. 5 illustrates the principles of subspace learning in anomaly detection according to embodiments of the present disclosure. It is known that normal metric vectors roughly lie on the principle subspace 501 of the vector space of storage usage and CPU load, and abnormal vectors 502 are far away from the principle subspace 501, which will be detected and reported. The key idea behind rank k subspace based anomaly detection is that real-world sketch matrix often has most of its variance in a low-dimensional rank k principle subspace, where k is usually much smaller than the number of columns of the sketch matrix. In a specific example, k equals to the number of all principle components, and in that case, the rank k principle subspace is also referred to as full rank principle subspace.

At step 332, a projection value of each of the at least one observational performance metric vector on at least part of the subspace is obtained, wherein the at least part of the subspace is the rank k principle subspace, i.e., partial rank principle subspace in case that k<the number of all principle components, or full rank principle subspace in that that k=the number of all principle components.

The projection value comprises any of rank-k leverage scores and rank k projection distance. These scores are based on identifying this principal k subspace using Principal Component Analysis (PCA) and then computing how “normal” the projection of a point on the principal k subspace looks. Rank-k leverage scores compute the normality of the projection of the point onto the principal k subspace using Mahalanobis distance, and rank k projection distance compute the distance of the point from the principal k subspace (see FIG. 1 for an illustration).

The following is a description of leverage scores obtained according to embodiments of the present disclosure. Given the sketch matrix B∈ [symbol] , let bᵢ∈R^{m} denote its i^{th} row. Let UΣV^{T} be the SVD of B where Σ=diag([ [symbol] ₁, . . . , [symbol] ]), [symbol] ₁≥ . . . ≥ [symbol] ≥0. Let Kₖ be the condition number of the top k principle subspace of B, defined as Kₖ= [symbol] / [symbol] . We consider all vectors as row vectors (that includes bᵢ). We denote by ∥B∥_{F} the Frobenius norm of the sketch matrix, and by ∥B∥ the operator norm (which is equal to the largest singular value). Subspace based measures of anomalies have their origins in a classical metric in statistics known as Mahalanobis distance, denoted by L(i) and defined as:

$$L ( i ) = {\sum }_{j = 1}^{ℓ} {( {b}_{i}^{T} {v}_{j} )}^{2} / {j}_{2}^{} .$$

where [symbol] is the number of rows of B, bᵢ is the i^{th} row of B, and vⱼ is the right singular vector of B, σⱼ is singular value of B. In order to make the solution robust, we pick the K right singular vectors with the top K singular values. L(i) is also known as the leverage score. Note that the higher leverage scores correspond to outliers, i.e., the anomalies in the sketch matrix.

However, L(i) depends on the entire spectrum of singular values and is highly sensitive to smaller singular values, whereas real world vectors often have most of their signal in the top singular values. Therefore the above sum is often limited to only the k largest singular values (for some appropriately chosen K<<d). This measure is called the rank K leverage score L^{k}(i), where

$${L}^{K} ( i ) = {\sum }_{j = 1}^{K} {( {b}_{i}^{T} {v}_{j} )}^{2} / {j}_{2}^{} .$$

The following is a description of projection distance obtained according to embodiments of the present disclosure. The projection distance T(i) is simply the distance of the vector bᵢ to the principal subspace:

$$T ( i ) = {\sum }_{j = k + 1}^{ℓ} {( {b}_{i}^{T} {v}_{j} )}^{2} ,$$

Or the distance of the vector bᵢ to the rank K principle subspace:

$${T}^{K} ( i ) = {\sum }_{j = 1}^{K} {( {b}_{i}^{T} {v}_{j} )}^{2} .$$

Note that the higher projection distances correspond to outliers, i.e., the anomalies in the sketch matrix.

At step 333, the result of anomaly detection from the projection value is obtained. In an example, the result is obtained by comparing the projection value with a predetermined threshold, which is predetermined from experiences. If the leverage score is larger than a predetermined threshold, anomaly is detected. Similarly, if the projection distance is larger than a predetermined threshold, anomaly is detected.

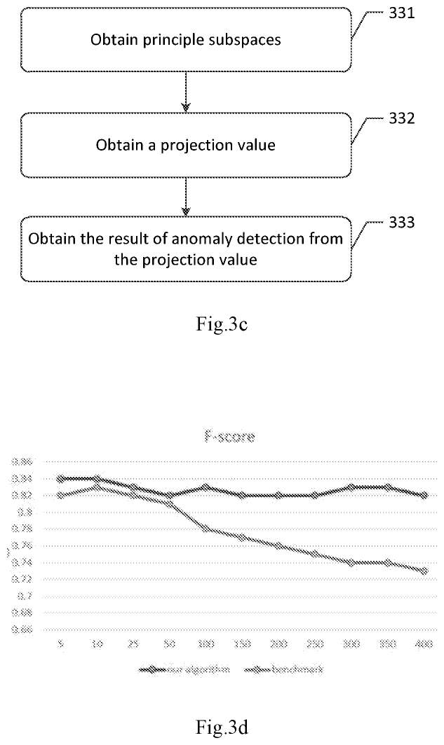

As embodiments of the present disclosure apply a streaming manner (i.e., the data comes in and is processed continuously) in matrix sketching, the anomaly detection becomes time efficient and resource efficient. FIGS. 4a and 4b show the streaming aspect of the embodiments of the present disclosure. FIG. 4a shows the streaming aspect in a schematic view of an anomaly detection system. In the anomaly detection system, one or more agents 201 collect the performance metric data, which will be transformed to performance metric vectors 402 in the agent 201, or in the communication device 401, or any other node (such as an intermediate node between them), only the first of which is shown in FIG. 4a. The performance metric vectors then get in a queue to be consumed by the streaming process 404 in the communication device 401. The streaming process 404 refers to the steps described above with reference to FIGS. 3a-3c in a streaming manner, with a streaming manner in matrix sketching being applied. The communication device 401 could be the edge computing node 103, and it could be the backend 205 as well, where the anomaly detection is performed. One or more storage(s) 405 is involved in the streaming process 404. The storage(s) 405 comprises a permanent data storage denoted as non-versatile storage 406 in the figure, and a versatile storage 407. The streaming process 404 may write to the non-versatile storage 406 data such as the result of the anomaly detection. The streaming process 404 may communicate with the versatile storage 407 for matrix sketching, sketch matrix updating, mean vector updating, subtracted performance metric vectors obtaining, projection value obtaining, etc. All of the intermediate data may be kept in the versatile storage 407 for further processing by the streaming process.

FIG. 4b illustrates the streaming process for anomaly detection in another schematic view simply with regard to the communication device 401 responsible for anomaly detection. As the data stream comes in, the streaming process 404 the machine learning algorithm 411 works with the support of the versatile storage 407 such as a cache in the communication device 401 responsible for anomaly detection. Parameters may also be input as the data streams in. The parameters may be entered by a user and include performance metric data sampling interval, selection of performance metric data, and a predetermined threshold value used for obtaining the result of anomaly detection from the projection value. Only a small length of versatile storage 407 is required due to the sketch matrix is applied and the streaming manner of matrix sketching is applied. Once an anomaly is detected, a report will be generated and sent to e.g. a center monitor such as the backend 205.

With the streaming manner, detections of anomalies in various hardware and software systems become time efficient and light weighted, can be discovered with little storage resource. Such a light weighted streaming process could thus be easily deployed at the edge side, such as the base station, or any other edge computing node.

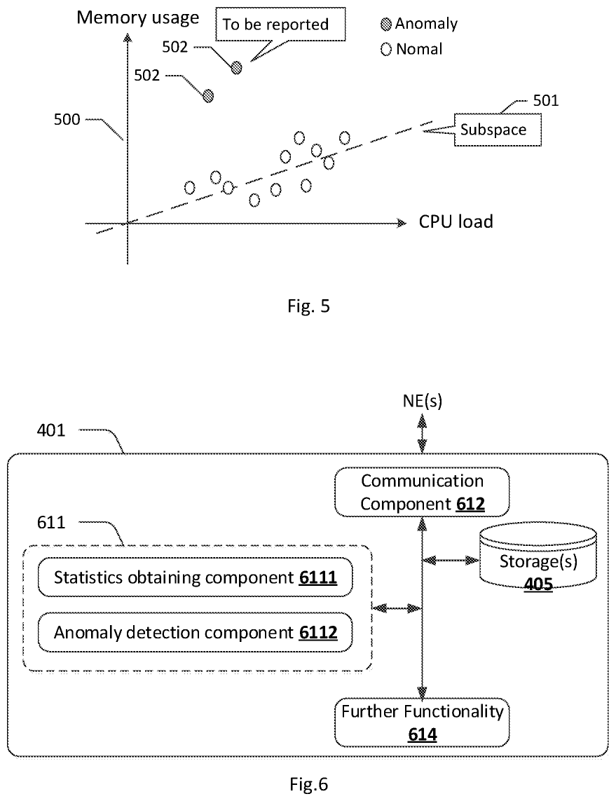

FIG. 6a illustrates a schematic block diagram of a communication device operative in a communication network according to embodiments of the present disclosure. The communication device 401 may be an edge computing node, and the communication network here may be a next generation network such as a 5G network, a next generation network in combination with a legacy network, or any other appropriate network.

The part of the communication device 401 which is most affected by the adaptation of the herein described method, e.g., a part of the method described with reference to FIG. 3a-3c, is illustrated as an arrangement 611, surrounded by a dashed line. The Communication device 401 and arrangement 611 may be further configured to communicate with other network entities (NE) such as the agent or the backend via a communication component 612 which may also be regarded as part of the arrangement 611 (not shown). The communication component 612 comprises means for communication. The arrangement 611 or the Communication device 401 may further comprise a further functionality 614, such as functional components providing regular edge computing functions, and may further comprise one or more storage(s) 405.

The arrangement 611 could be implemented, e.g., by one or more of: a processor or a microprocessor and adequate software and storage for storing of the software, a Programmable Logic Device (PLD) or other electronic component (s) or processing circuitry configured to perform the actions described above, and illustrated, e.g., in FIGS. 3a-3c. The arrangement 611 of the Communication device 401 may be implemented and/or described as follows.

Referring to FIG. 6, the Communication device 401 may comprise a statistics obtaining component 6111 and an anomaly detection component 6112. The statistics obtaining component 6111 is configured to obtain a mean vector and a sketch matrix, wherein the mean vector is a mean of the performance metric vectors indicating status of the system, and the sketch matrix is a sketch of an original matrix generated from subtracted performance metric vectors, the subtracted performance metric vectors resulting from subtracting the mean vector from each of the performance metric vectors. Details of the action may be found in step 301 as described above and will not be iterated herein.

The anomaly detection component 6112 is configured to obtain a result of anomaly detection for at least one observational performance metric vector indicating status of the system, based on the mean vector and the sketch matrix. Details of the action may be found in step 302 as described above and will not be iterated herein.

It should be noted that two or more different units in this disclosure may be logically or physically combined.

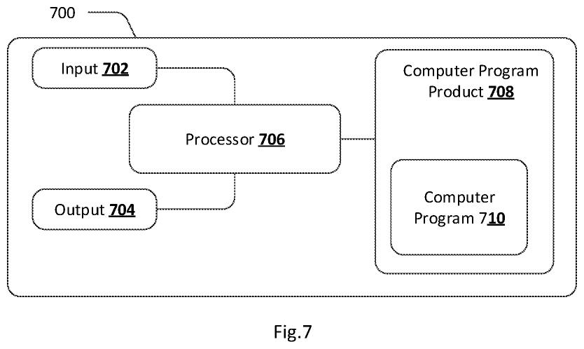

FIG. 7 schematically shows an embodiment of an arrangement 700 which may be used in the Communication device 401 or the agent 201. Comprised in the arrangement 700 are here a processor 706, e.g., with a Digital Signal Processor (DSP). The processor 706 may be a single unit or a plurality of units to perform different actions of procedures described herein. The arrangement 700 may also comprise an input unit 702 for receiving signals from other entities, such as the sensed data and an output unit 704 for providing signal(s) to other entities. The input unit and the output unit may be arranged as an integrated network element, or a hardware component such as a sensing component.

Furthermore, the arrangement 700 comprises at least one computer program product 708 in the form of a non-volatile or volatile storage, e.g., an Electrically Erasable Programmable Read-Only Memory (EEPROM), a flash memory and a hard drive, and those from a network or a cloud connected via the input unit 702 and output unit 704. The computer program product 708 comprises a computer program 710, which comprises code/computer readable instructions, which when executed by the processor 706 in the arrangement 700 causes the arrangement 700 and/or the Communication device 401 or the agent in which it is comprised to perform the actions, e.g., of the procedure described earlier in conjunction with FIGS. 3a-3c.

The computer program 710 may be configured as a computer program code structured in computer program modules. Hence, in an exemplifying embodiment when the arrangement 700 is used in the Communication device 401, the code in the computer program of the arrangement 700 when executed, will cause the processor 706 to perform the steps as described with reference to FIGS. 3a-3c.

The processor 706 may be a single Central Processing Unit (CPU), but could also comprise two or more processing units. For example, the processor 706 may include general purpose microprocessors, instruction set processors and/or related chip sets and/or special purpose microprocessors such as Application Specific Integrated Circuits (ASIC). The processor 706 may also comprise board memory for caching purposes. The computer program 710 may be carried by a computer program product 708 connected to the processor 706. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories. The computer program product may also comprise an electronic signal, optical signal, or radio signal, etc. in which the computer program is transmitted.

As a whole or by scenario, with the matrix sketching and furthermore matrix sketching in a streaming manner, anomalies in various hardware and software systems become time efficient and light weighted, can be discovered with little storage resource. Such a light weighted streaming process could thus be easily deployed at the edge side, such as the base station, or any other edge computing node. As the edge side is near to the monitored system(s), and such short distance communication may save time and transmission bandwidth for anomaly detection. Generally in the next generation networks such 5G communication network, an edge computing node is deployed and owned by a private network, then performance metric data generated locally could be processed locally, without security problems caused in public networks. By generating a matrix from vectors resulted from subtracting the mean vector from observational performance metric vectors, accuracy in anomaly detection may be enhanced. By processing observational data from a plurality of systems that share a job evenly in the same process, the anomaly detection may become more robust and not affected by abrupt performance metric data change easily.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1.-23. (canceled)

24. A method for anomaly detection performed in an edge computing node of a system, comprising:
obtaining a mean vector and a sketch matrix, wherein the mean vector is a mean of performance metric vectors indicating status of the system, and the sketch matrix is a sketch of an original matrix, the original matrix being generated from subtracting the mean vector from each of the performance metric vectors, and
obtaining a result of anomaly detection for at least one observational performance metric vector indicating status of the system, based on the mean vector and the sketch matrix.

25. The method of claim 24, wherein in response to determining a cold start process where the system is run for generating the performance metric vectors indicating status of the system for a time period and statistics comprising the mean vector and the sketch matrix are calculated according to the performance metric vectors generated in the process, is required, the obtaining the mean vector and the sketch matrix comprises:
obtaining performance metric vectors indicating status of the system within the time period,
obtaining the mean vector, which results from calculation of a mean of the performance metric vectors indicating status of the system within the time period,
obtaining subtracted performance metric vectors within the time period, which result from subtraction of the mean vector from each of the performance metric vectors indicating status of the system within the time period, and
obtaining the original matrix, which is generated from the subtracted performance metric vectors within the time period.

26. The method of claim 25, further comprising:
determining the cold start process is required when:
the status of the system has changed abruptly,
the system starts up for the first time,
the system is upgraded with regard to any of its component,
at least part of components of the system is replaced, or
it is at time predefined for a regular cold start process.

27. The method of claim 24, wherein the system comprises a plurality of subsystems that share a job evenly and the performance metric vectors indicating status of the system comprises performance metric vectors indicating status of each of the subsystem.

28. The method of claim 24, wherein obtaining the sketch matrix of the original matrix comprises:
reading the original matrix once.

29. The method of claim 24, wherein in case that the original matrix is generated with each row of the original matrix being one of the subtracted performance metric vectors, the sketch matrix of the original matrix comprises any of the following:
a Frequent Direction sketch matrix of the original matrix,
a sketch matrix obtained by randomly combining rows of the original matrix, or by randomly combining rows of the original matrix, or
a sketch matrix obtained by generating a sparser version of the original matrix,
wherein whether the sketch matrix is generated on rows of the original matrix, or on columns of the original matrix, depends on how the original matrix is generated.

30. The method of claim 24, wherein the obtaining the result of anomaly detection comprises:
obtaining principle subspace of the sketch matrix using Principal Component Analysis,
obtaining a projection value of each of the at least one observational performance metric vector on at least part of the principle subspace, wherein the at least part of the principle subspace is partial rank or full rank principle subspace, and
obtaining the result of anomaly detection from the projection value.

31. The method of claim 30, wherein the projection value comprises any of the following: a leverage score on at least part of the principle subspace, or a projection distance on at least part of the principle subspace.

32. The method of claim 24, further comprising:
in response to that an anomaly is detected from the result, reporting the anomaly.

33. The method of claim 24, further comprising:
in response to no anomaly is detected in one of the at least one observational performance metric vector from the result, updating the mean vector and the sketch matrix with the one of the at least one observational performance metric vector.

34. The method of claim 24, wherein the system comprises any of the following: a hardware system, software system, or environmental system.

35. The method of claim 24, wherein the system comprises at least an entity of a 5G network.

36. The method of claim 24, wherein the original matrix is generated with each row of the original matrix comprising a respective one vector of the subtracted performance metric vectors.

37. The method of claim 24, wherein the at least one observational performance metric vector is generated in real time.

38. An apparatus for anomaly detection in a system, the apparatus comprising processing circuitry configured to:
obtain a mean vector and a sketch matrix, wherein the mean vector is a mean of the performance metric vectors indicating status of the system, and the sketch matrix is a sketch of an original matrix, the original matrix being generated from subtracting the mean vector from each of the performance metric vectors, and
obtain a result of anomaly detection for at least one observational performance metric vector indicating status of the system, based on the mean vector and the sketch matrix.

39. A communication device configured to operate in a communication network, comprising:
a storage adapted to store instructions therein;
a processor adapted to execute the instructions to cause the communication device to:
obtain a mean vector and a sketch matrix, wherein the mean vector is a mean of performance metric vectors indicating status of a system, and the sketch matrix is a sketch of an original matrix, the original matrix being generated from subtracting the mean vector from each of the performance metric vectors, and
obtain a result of anomaly detection for at least one observational performance metric vector indicating status of the system, based on the mean vector and the sketch matrix.

40. An anomaly detection system, comprising:
at least one agent entity, configured to collect performance metric data used for
generating performance metric vectors indicating status of a system, and the anomaly detection apparatus of claim 39.

41. The anomaly detection system of claim 40, wherein the at least one agent entity comprises at least one sensor.
